(19) United States
(12) Patent Application Publication
(10) Pub. No.: US 2012/0169931 A1
(43) Pub. Date: Jul. 5, 2012

(54) PRESENTING CUSTOMIZED BOOT LOGO ON TV DISPLAY

(75) Inventor: BIBHUDENDU MOHAPATRA, San Diego, CA (US)

(73) Assignee: SONY CORPORATION

(21) Appl. No.: 12/984,143

(22) Filed: Jan. 4, 2011

(51) Int. Cl. H04N 5/445

(52) U.S. Cl. 348/563; 348/E05.099

(57) ABSTRACT

A custom logo that may be presented during, e.g., TV boot is stored on a first storage such as a NAND flash and caused to be presented on the TV display during booting. In the event that the custom logo is not present on the first storage, a default logo on a second storage containing the boot loader of the TV is presented on the display.

### I. FIELD OF THE APPLICATION

The present application relates generally to presenting customized boot logos on TV displays.

### II. BACKGROUND OF THE APPLICATION

As is the case with personal computers, modern TVs have operating systems and “boot loaders”, essentially a program that loads the main operating systems into memory during a “boot” process. Among other TV-centric functions, boot loaders, during boot, can cause a logo to be presented on the TV display, typically the logo of the TV manufacturer. As understood herein, it would be advantageous from a marketing viewpoint to customize the boot logo for institutions such as hotels that might purchase many TVs.

### SUMMARY OF THE INVENTION

As also recognized by present principles, it would be advantageous to supply the customized logo to a customer on site, while avoiding copying the customized logo over the default manufacturer logo on the same storage medium that holds the boot loader, for at least two reasons. First, loading additional data in the field onto the storage medium that holds the boot loader risks corrupting the boot loader. If this occurs, a technician visit to correct the problem and enable normal use of the TV typically is required. Second, present principles understand that in the event that the customized logo becomes corrupted, no logo at all will be displayed since the default manufacturer logo was overwritten, leaving an undesirable blank screen during booting.

Accordingly, a display apparatus includes video display and a processor communicating with the video display. A serial flash bears a default logo while a NAND flash different from the serial flash is also provided, and the processor communicates with both the serial flash and NAND flash. The processor accesses a storage device bearing computer readable instructions to determine whether a first logo is on the NAND flash. Responsive to a determination that the first logo is not on the NAND flash, the processor accesses the serial flash to read a second logo therefrom and presents the second logo on the display. However, responsive to a determination that the first logo is on the NAND flash, the processor accesses the NAND flash to read the first logo therefrom, presenting the first logo on the display. The first and second logos are different from each other.

In some embodiments the processor determines whether the first logo is on the NAND flash by reading a flag. The flag may be on the serial flash. The processor can execute a boot loader to determine whether the first logo is on the NAND flash and the boot loader can be on the serial flash. Typically, after presenting the first or second logo on the display the processor completes a boot operation at least in part by loading a main operating system.

If desired, the processor may, responsive to determining that the first logo is on the NAND flash, attempt to read the first logo and then determine whether the read was valid. Responsive to a determination that the read was valid, the processor can present the first logo on the display. In contrast, responsive to a determination that the read was not valid, the processor may indicate that the read was not valid and present an image of the second logo on the display.

In another aspect, a method for loading a custom logo onto a TV includes receiving an initial image of the custom logo, compressing the image to render a compressed image, and providing a format of the compressed image to the TV. The TV is caused to load the compressed image onto a NAND flash in the TV. Also, the TV is caused to indicate that the compressed image is on the NAND flash.

In another aspect, a display device includes a processor, a first storage accessible to the processor, and a second storage accessible to the processor and bearing a boot loader executable by the processor to boot a main operating system in the display device. The processor, responsive to reading a custom logo on the first storage, presents on the display the custom logo. On the other hand, responsive to attempting to read the custom logo on the first storage and failing, the processor presents on the display a default logo different from the custom logo.

The details of the present invention, both as to its structure and operation, can best be understood in reference to the accompanying drawings, in which like reference numerals refer to like parts, and in which:

### BRIEF DESCRIPTION OF THE DRAWINGS

FIG. 1 is a perspective view of an example TV in an exploded relationship with a universal serial bus (USB) storage device;

FIG. 2 is a block diagram of an example TV, showing certain electronic components;

FIG. 3 is a flow chart of example logo copy logic; and

FIG. 4 is a flow chart of example logo display logic.

### DETAILED DESCRIPTION OF THE PREFERRED EMBODIMENT

Referring initially to the non-limiting example embodiment show in FIG. 1, a system 10 includes an audio video device such as a TV 12 including a TV display 14 such as but not limited to a high definition flat panel display. Audio is played over one or more speakers 16. The TV display 14 may be mounted on the wall, on a stand 18 as shown, or otherwise vertically positioned for viewing.

As shown in FIG. 1, the TV 12 may also include a universal serial bus (USB) port tuner 20 into which a USB storage device 22 such as a so-called “thumb drive” or “pen drive” may be inserted. The USB device 22 may carry an image 24 of a customized logo that can be presented on the display 14 as shown during, e.g., booting. In the absence of a customized logo image 24, an image of a default logo that is different than the customized logo can be presented on the display as described below. It is to be understood that loading the customized logo image 24 into the TV 12 using the USB device 22 is not limiting, and that other methods for loading the logo may be used, e.g., by sending the logo to the TV through a cable head end and cable TV connection or by sending the logo to the TV from a web site through an Internet browser executed by the below-described TV processor.

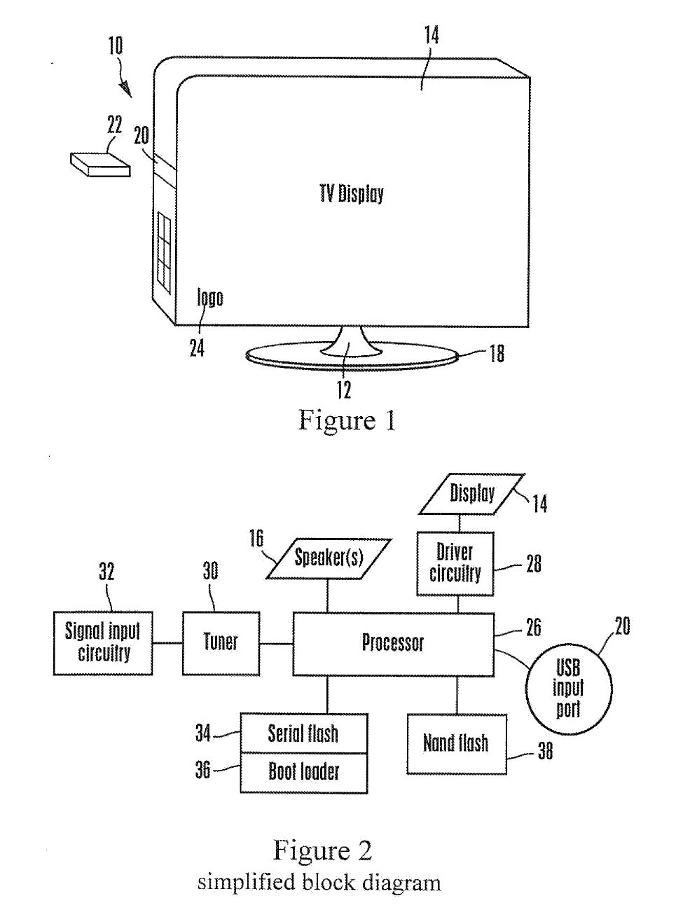

Turning to FIG. 2, elements of the electronics of the TV 12 may be seen that are relevant to present principles. The elements in FIG. 2 typically are all contained in the same chassis as the processor 26 and display 14. A TV processor controls the display 14 typically through driver circuitry 28. The processor 26 also controls the speakers 16. TV programming received from a TV tuner 30 under control of the processor 26 is presented on the display 14 and speakers 16. The programming is received by the tuner 30 typically from signal input circuitry 32 that can receive signals from a terrestrial antenna, a satellite receiver, a set-top box, a cable head end bypassing the set-top box, etc.

As further shown in FIG. 2, the TV processor 26 typically accesses one or more tangible computer readable storage media such as disk-based or solid state storage. In the embodiment shown, the TV processor 26 accesses a serial (“NOR”) flash storage device 34 that may store the boot loader 36 of the TV for booting a main operating system such as Linux. The serial flash device 34 may also store a default logo that is different from the customized logo of the image 24 shown in FIG. 1. The TV processor may also access a NAND flash storage device 38. The TV processor 26 communicates with the USB port 20 as shown.

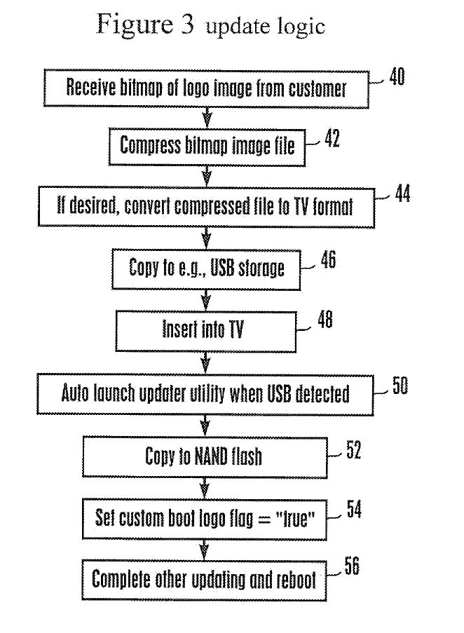

FIG. 3 shows example logic by which the logo image 24 is received and stored. Commencing at block 40, an initial logo image is received, typically as a bitmap and typically from a customer purchasing the TV and affiliated with the logo. For example, the image 24 may be a hotel corporation logo, while the default logo on the serial flash 34 typically is factory loaded and is the logo of the TV manufacturer. The number of bits per pixel in the received bitmap image may be, e.g., is 24 or 32, which is the color depth. Also, the number of image planes in the bitmap image preferably may be limited to one. If desired, the bitmap image may be 960×540 pixels.

Moving to block 42, a computer such as a factory computer may compress the received bitmap image, typically using a lossless compression algorithm. Proceeding to block 44, the now compressed image file may be converted to a format appropriate for the TV and then the compressed and converted image file copied to the USB device 22 at block 46.

Block 48 indicates that when the USB device 22 is the vehicle used for providing the image 24 to the TV, the USB device 22 is inserted into the USB port 20. Proceeding to block 50, when the TV processor 26 detects the insertion of the USB device 22 in the USB port 20 it may automatically launch an update utility which copies the image on the USB device 22 onto the NAND flash storage device 38 at block 52. The processor 26, at block 54, sets a custom boot logo flag on the NOR flash 34 to be “TRUE” and then completes any additional updating at block 56, rebooting when updating is complete. Note that portions of the logic disclosed herein executed by the TV processor 26 may be embodied in software on either of the above-described flash devices or on another appropriate electronic storage device accessible to the processor, so that the processor(s) herein execute logic embodied in instructions on a tangible computer storage medium.

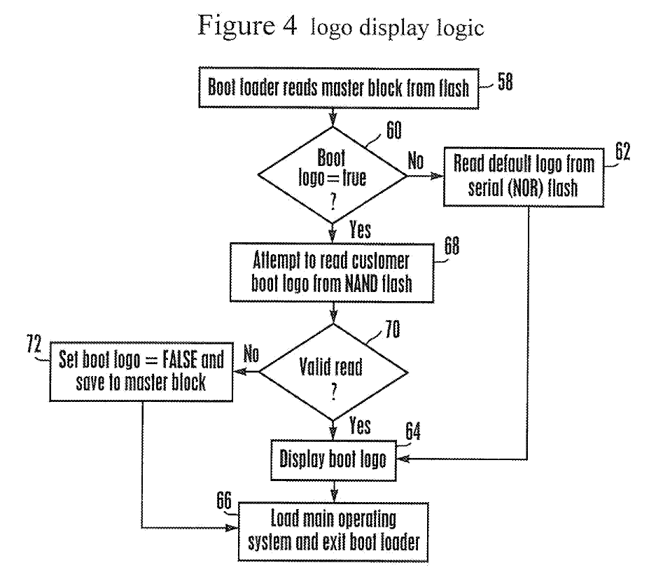

Now referring to FIG. 4, regardless of the vehicle for loading the custom logo image 24 into the TV, at subsequent boot times the boot loader 36 reads the custom boot logo flag on the NOR flash 34, typically by reading the master block from the serial flash 34. If the flag is FALSE at decision diamond 60 the logic moves to block 62 to read the default logo from the serial flash 34, presenting the default logo on the display 14 at block 64. The boot loader then proceeds to block 66 to complete the boot by loading the main operating system, after which the boot loader exits.

On the other hand, when the custom boot logo flag on the NOR flash 34 is found to be TRUE at decision diamond 60, the logic flows to block 68 to attempt to read the file on the NAND flash 38 that bears the custom logo image 24. If the read is found to be valid at decision diamond 70 the image 24 of the custom logo is presented on the display 14, and the logic continues to block 66 to function as described above.

In contrast, if the read of the NAND flash 38 is not found to be valid at decision diamond 70, the logic flows to block 72 to set the custom boot logo flag on the NOR flash 34 to be FALSE. The new flag value is saved in the master block of the serial flash 34. The logic then proceeds to block 66 to complete the boot by loading the main operating system without displaying any logo, after which the boot loader exits. Subsequent boots will thus find the custom boot logo flag on the NOR flash 34 to be FALSE at decision diamond 60 and proceed as described above to present the default logo on the display.

While the particular PRESENTING CUSTOMIZED BOOT LOGO ON TV DISPLAY is herein shown and described in detail, it is to be understood that the subject matter which is encompassed by the present invention is limited only by the claims.

What is claimed is:

1. Display apparatus comprising:
at least one video display;
at least one processor communicating with the video display;
at least one serial flash bearing at least a default logo;
at least one NAND flash different from the serial flash, the processor communicating with the serial flash and NAND flash;
the processor accessing a storage device bearing computer readable instructions to determine whether a first logo is on the NAND flash, and responsive to a determination that the first logo is not on the NAND flash, access the serial flash to read a second logo therefrom and present the second logo on the display, and responsive to a determination that the first logo is on the NAND flash, access the NAND flash to read the first logo therefrom and present the first logo on the display, the first and second logos being different from each other.

2. The display apparatus of claim 1, wherein the processor determines whether the first logo is on the NAND flash by reading a flag.

3. The display apparatus of claim 2, wherein the flag is on the serial flash.

4. The display apparatus of claim 1, wherein the processor executes a boot loader to determine whether the first logo is on the NAND flash.

5. The display apparatus of claim 4, wherein the boot loader is on the serial flash.

6. The display apparatus of claim 1, wherein after presenting the first or second logo on the display the processor completes a boot operation at least in part by loading a main operating system.

7. The display apparatus of claim 1, wherein responsive to determining that the first logo is on the NAND flash the processor attempts to read the first logo and determines whether the read was valid, and responsive to a determination that the read was valid, the processor presents the first logo on the display, and responsive to a determination that the read was not valid, the processor indicates that the read was not valid and presents an image of the second logo on the display.

8. Method for loading a custom logo onto a TV comprising:
receiving an initial image of the custom logo;
compressing the image to render a compressed image;
providing a format of the compressed image to the TV;
causing the TV to load the compressed image onto a NAND flash in the TV;
causing the TV to indicate that the compressed image is on the NAND flash.

9. The method of claim 8, wherein the initial image is received as a bitmap.

10. The method of claim 8, wherein a number of bits per pixel in the initial image is 24 or 32.

11. The method of claim 10, wherein a number of image planes in the initial image is one.

12. The method of claim 8, wherein a lossless compression algorithm is used to compress the initial image.

13. The method of claim 8, comprising storing the compressed image on a USB device.

14. The method of claim 13, comprising, responsive to detecting engagement of the USB device with the TV, automatically copying the compressed image on the USB device onto the NAND flash.

15. The method of claim 14, comprising setting a flag on a NOR flash in the TV to be “TRUE” responsive to copying the compressed image on the USB device onto the NAND flash.

16. A display device comprising:
at least one processor;
at least a first storage accessible to the processor;
at least a second storage accessible to the processor and bearing a boot loader executable by the processor to boot a main operating system in the display device;
the processor, responsive to reading a custom logo on the first storage, presenting on the display the custom logo, the processor, responsive to attempting to read the custom logo on the first storage and failing, presenting on the display a default logo different from the custom logo.

17. The display device of claim 16, wherein the default logo is stored on the second storage.

18. The display device of claim 16, wherein the first storage is NAND flash.

19. The display device of claim 16, wherein the second storage is serial flash.

20. The display device of claim 16, wherein responsive to determining that the custom logo is on the first storage the processor attempts to read the custom logo and determines whether the read was valid, and responsive to a determination that the read was valid, the processor presents the custom logo on the display, and responsive to a determination that the read was not valid, the processor indicates that the read was not valid and presents the default logo on the display.
